(19) United States
(12) Patent Application Publication
(10) Pub. No.: US 2025/0263968 A1
(43) Pub. Date: Aug. 21, 2025

(54) SHOWER DOOR HARDWARE ASSEMBLY

(71) Applicant: LIBERTY HARDWARE MFG. CORP., Winston-Salem, NC (US)

(72) Inventors: Nathaniel Faltin Dutton SCHULTZ, Charlotte, NC (US); Tom SIMEK, Winston-Salem, NC (US); Michael GLASER, Winston-Salem, NC (US); Anthony PLAZIO, Winston-Salem, NC (US)

(21) Appl. No.: 19/054,224

(22) Filed: Feb. 14, 2025

Related U.S. Application Data
(60) Provisional application No. 63/554,296, filed on Feb. 16, 2024.

(51) Int. Cl. E06B 3/02; A47K 3/30; E05D 3/02; E06B 1/60

(52) U.S. Cl. CPC E06B 3/02; A47K 3/30; E05D 3/02; E06B 1/6069

(57) ABSTRACT

A shower door hardware assembly is provided with a mount to be mounted to an upright support surface. A bracket is attachable to the mount. A clamp is oriented on the bracket to receive, clamp, and support a shower door panel. A shim is sized to be received between the mount and the upright support surface to adjust a position of the bracket. A hinge subassembly is provided with a plurality of apertures to be fastened to another upright support surface and to pivotally support a shower door panel. A shim is sized to be received between the hinge subassembly and the upright support surface to adjust a position of the hinge subassembly relative to the upright support surface, wherein the shim includes a slot aligned with at least one of the plurality of apertures for installation while the hinge subassembly is fastened to the upright support surface.

### CROSS-REFERENCE TO RELATED APPLICATIONS

This application claims the benefit of U.S. provisional application Ser. No. 63/554,296 filed Feb. 16, 2024, the disclosure of which is hereby incorporated in its entirety by reference herein.

### TECHNICAL FIELD

Various embodiments relate to shower door hardware assemblies and shower door assemblies.

### BACKGROUND

A shower door hinge is disclosed in Austin, III, U.S. Pat. No. 9,080,357 B1, which issued Jul. 14, 2015, to Liberty Hardware Mfg. Corp.

### SUMMARY

According to one embodiment, a shower door hardware assembly is provided with a mount adapted to be mounted to an upright support surface. A bracket is attachable to the mount. A clamp is oriented on the bracket to receive, clamp, and support a shower door panel. A shim is sized to be received between the mount and the upright support surface to adjust a position of the bracket relative to the upright support surface.

According to a further embodiment, the bracket is not adjustable relative to the mount.

According to another further embodiment, an aperture is formed through the clamp and sized to receive a distal end of the bracket.

According to an even further embodiment, a plug is sized to be received in the aperture of the clamp.

According to another even further embodiment, the clamp is further provided with a surface finish or a coating. The plug is provided with a surface finish or a coating to match that of the clamp.

According to another even further embodiment, a fastener is in cooperation with the clamp and the plug to retain the plug within the aperture of the clamp.

According to another further embodiment, the shim is provided with an angled thickness.

According to an even further embodiment, an angle of the angled thickness of the shim is five degrees or less.

According to another further embodiment, the shim is provided with a length and a height sized to match the mount.

According to another further embodiment, the shim is provided from a polymeric material.

According to another further embodiment, the shim is provided from a silicone material.

According to another even further embodiment, the shim is provided from a nylon material.

According to another embodiment, a shower door assembly is provided with a panel sized to be installed in a shower stall opening. A shower door hardware assembly is provided with a mount adapted to be mounted to an upright support surface to install and support the panel in the shower stall opening. A bracket is attachable to the mount at a proximal end of the bracket. A clamp is oriented at a distal end of the bracket to receive, clamp, and support a shower door panel. A shim is sized to be received between the mount and the upright support surface to adjust a position of the bracket relative to the upright support surface.

According to a further embodiment, a channel is sized to be installed to a sill of the shower stall opening and sized to receive the panel in the channel. A support is sized to be received within the channel to receive and support the panel.

According to another embodiment, a shower door hardware assembly is provided with a mount adapted to be mounted to an upright support surface. A bracket is attachable to the mount, wherein the bracket is not adjustable relative to the mount. A clamp is oriented on the bracket to receive, clamp, and support a shower door panel.

According to another embodiment, a shower door hardware assembly is provided with a mount adapted to be mounted to an upright support surface. A bracket is attachable to the mount at a proximal end of the bracket. A clamp has an aperture formed therethrough and sized to receive a distal end of the bracket, the clamp is operable to receive, clamp, and support a shower door panel. A plug is sized to be received in the aperture of the clamp.

According to another embodiment, a shower door hardware assembly is provided with a hinge subassembly with a plurality of apertures to be fastened to an upright support surface and to pivotally support a shower door panel relative to the upright support surface. A shim is sized to be received between the hinge subassembly and the upright support surface to adjust a position of the hinge subassembly relative to the upright support surface, wherein the shim includes a slot aligned with at least one of the plurality of apertures for installation while the hinge subassembly is fastened to the upright support surface.

According to a further embodiment, the shim is formed from a flexible polymeric material.

According to another embodiment, a shower door assembly is provided with a panel sized to be installed in a shower stall opening. A shower door hardware assembly is provided with a hinge subassembly with a plurality of apertures to be fastened to an upright support surface and to pivotally support a shower door panel relative to the upright support surface to install and pivotally support the panel in the shower stall opening. A shim is sized to be received between the hinge subassembly and the upright support surface to adjust a position of the hinge subassembly relative to the upright support surface, wherein the shim includes a slot aligned with at least one of the plurality of apertures for installation while the hinge subassembly is fastened to the upright support surface.

According to a further embodiment, a support is sized to support the panel in the shower stall opening during installation of the panel to the hinge.

According to another embodiment, a shower door hardware assembly is provided with a mount adapted to be mounted to a first upright support surface. A bracket is attachable to the mount at a proximal end of the bracket, wherein the bracket is not adjustable relative to the mount. A clamp is oriented at a distal end of the bracket to receive, clamp, and support a shower door panel. A hinge subassembly is provided with a plurality of apertures to be fastened to a second upright support surface and to pivotally support a shower door panel relative to the second upright support surface. A shim is sized to be received between the hinge subassembly and the second upright support surface to adjust a position of the hinge subassembly relative to the second upright support surface, wherein the shim includes a slot aligned with at least one of the plurality of apertures for installation while the hinge subassembly is fastened to the second upright support surface.

According to another embodiment, a method is provided by installing a hinged shower door to a first upright support surface. A fixed shower door panel is installed to a second upright support surface that is spaced apart and opposed to the first upright support surface. A shim is installed between the fixed shower door panel and the second upright support surface to align the fixed shower door with the hinged shower door.

According to a further embodiment, a bracket is cut to length. The bracket is installed to the fixed shower door panel and the second upright support surface.

According to an even further embodiment a trim member is installed to conceal a cut end of the bracket.

According to another even further embodiment, a clamp is installed on the bracket. The clamp is clamped upon the fixed shower door panel. The trim member is installed on the clamp.

According to another even further embodiment, a clamp is installed on the bracket. The clamp is slid onto the fixed shower door panel. The bracket is slid into engagement with the first upright support surface. The bracket is installed to the first upright support surface. The fixed shower door panel is clamped to the clamp.

According to another even further embodiment, the fixed shower door panel is leveled.

According to another further embodiment, the hinged shower door is fastened to the first upright support surface. Fasteners are loosened from the hinged shower door to the first upright support surface. A slotted shim is installed upon the fasteners between the hinged shower door and the first upright support surface.

According to another embodiment, a method is provided by fastening a hinged shower door to an upright support surface. Fasteners are loosened from the hinged shower door to the upright support surface. A slotted shim is installed upon the fasteners between the hinged shower door and the upright support surface.

One general embodiment includes a shower door hardware assembly that also includes a mount adapted to be mounted to an upright support surface. The assembly also includes a bracket attachable to the mount. The assembly also includes a clamp on the bracket to receive, clamp, and support a shower door panel. The assembly also includes a shim sized to be received between the mount and the upright support surface to adjust a position of the bracket relative to the upright support surface.

Implementations may include one or more of the following features. The shower door hardware assembly where the bracket is not adjustable relative to the mount. An aperture is formed through the clamp and sized to receive the distal end of the bracket. The shower door hardware assembly may include a plug sized to be received in the aperture of the clamp. The clamp may include a surface finish or a coating; and where the plug may include a surface finish or a coating to match that of the clamp. The shower door hardware assembly may include a fastener in cooperation with the clamp and the plug to retain the plug within the aperture of the clamp. The shim may include an angled thickness. An angle of the angled thickness of the shim is five degrees or less. The shim may include a length and a height sized to match the mount. The shim may include a polymeric material. The shim may include a silicone material. The shim may include a nylon material. A shower door assembly may include: a panel sized to be installed in a shower stall opening, and the shower door hardware assembly to install and support the panel in the shower stall opening. The shower door assembly may include: a channel sized to be installed to a sill of the shower stall opening and sized to receive the panel in the channel; and a support sized to be received within the channel to receive and support the panel. Implementations of the described techniques may include hardware, a method or process.

Another general embodiment includes a shower door hardware assembly that also includes a mount adapted to be mounted to an upright support surface. The assembly also includes a bracket attachable to the mount, where the bracket is not adjustable relative to the mount. The assembly also includes a clamp oriented on the bracket to receive, clamp, and support a shower door panel.

Another general embodiment includes a shower door hardware assembly that also includes a mount adapted to be mounted to an upright support surface. The assembly also includes a bracket attachable to the mount at a proximal end of the bracket. The assembly also includes a clamp with an aperture formed therethrough and sized to receive a distal end of the bracket, the clamp operable to receive, clamp, and support a shower door panel. The assembly also includes a plug sized to be received in the aperture of the clamp.

Another general aspect includes a shower door hardware assembly that also includes a hinge subassembly with a plurality of apertures to be fastened to an upright support surface and to pivotally support a shower door panel relative to the upright support surface. The assembly also includes a shim sized to be received between the hinge subassembly and the upright support surface to adjust a position of the hinge subassembly relative to the upright support surface, where the shim includes a slot aligned with at least one of the plurality of apertures for installation while the hinge subassembly is fastened to the upright support surface.

Implementations may include one or more of the following features. The shower door hardware assembly where the shim is formed from a flexible polymeric material. A shower door assembly may include: a panel sized to be installed in a shower stall opening, and the shower door hardware assembly to install and pivotally support the panel in the shower stall opening. The shower door assembly may include a support sized to support the panel in the shower stall opening during installation of the panel to the hinge. Implementations of the described techniques may include hardware, a method or process, or computer software on a computer-accessible medium.

Another general embodiment includes a shower door hardware assembly that also includes a mount adapted to be mounted to a first upright support surface. The assembly also includes a bracket attachable to the mount at a proximal end of the bracket, where the bracket is not adjustable relative to the mount. The assembly also includes a clamp oriented at a distal end of the bracket to receive, clamp, and support a shower door panel. The assembly also includes a hinge subassembly with a plurality of apertures to be fastened to a second upright support surface and to pivotally support a shower door panel relative to the second upright support surface. The assembly also includes a shim sized to be received between the hinge subassembly and the second upright support surface to adjust a position of the hinge subassembly relative to the second upright support surface, where the shim includes a slot aligned with at least one of the plurality of apertures for installation while the hinge subassembly is fastened to the second upright support surface.

Another general embodiment includes a method that also includes installing a hinged shower door to a first upright support surface. The method also includes installing a fixed shower door panel to a second upright support surface that is spaced apart and opposed to the first upright support surface. The method also includes installing a shim between the fixed shower door panel and the second upright support surface to align the fixed shower door with the hinged shower door.

Implementations may include one or more of the following features. The method may include: cutting a bracket to length; and installing the bracket to the fixed shower door panel and the second upright support surface. The method may include: installing a trim member to conceal a cut end of the bracket. The method may include: installing a clamp on the bracket; clamping the clamp upon the fixed shower door panel; and installing the trim member on the clamp. The method may include: installing a clamp on the bracket; sliding the clamp onto the fixed shower door panel; sliding the bracket into engagement with the first upright support surface; installing the bracket to the first upright support surface; and clamping the fixed shower door panel to the clamp. The method may include: leveling the fixed shower door panel. The method may include: fastening the hinged shower door to the first upright support surface; loosening fasteners from the hinged shower door to the first upright support surface; and installing a slotted shim upon the fasteners between the hinged shower door and the first upright support surface.

Another general embodiment includes a method that also includes fastening a hinged shower door to an upright support surface. The method also includes loosening fasteners from the hinged shower door to the upright support surface. The method also includes installing a slotted shim upon the fasteners between the hinged shower door and the upright support surface. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a front perspective view of a shower door assembly installed in a shower stall according to an embodiment;

FIG. 2 is an exploded front perspective view of the shower door assembly of FIG. 1;

FIG. 3 is a side view of a rail of the shower door assembly of FIG. 1;

FIG. 4 is a side view of a gasket of the shower door assembly of FIG. 1;

FIG. 5 is a side view of a seal of the shower door assembly of FIG. 1;

FIG. 6 is a side view of an insert of the shower door assembly of FIG. 1;

FIG. 7 is a side view of a diverter of the shower door assembly of FIG. 1;

FIG. 8 is a side view of a seal of the shower door assembly of FIG. 1;

FIG. 9 is an exploded front perspective view of a hardware assembly of the shower door assembly of FIG. 1;

FIG. 10 is an exploded front perspective view of the shower door assembly of FIG. 1 illustrating an installation step according to an embodiment;

FIG. 11 is an exploded front perspective view of the shower door assembly of FIG. 1 illustrating another installation step according to an embodiment;

FIG. 12 is an enlarged partial rear perspective view of the shower door assembly of FIG. 1;

FIG. 13 is a front perspective view of a shim for the hardware assembly of FIG. 9;

FIG. 14 is an enlarged partial front perspective view of the shower door assembly of FIG. 1 illustrating an installation step according to an embodiment;

FIG. 15 is an enlarged partial front perspective view of the shower door assembly of FIG. 1 illustrating another installation step according to an embodiment;

FIG. 16 is an enlarged partial front perspective view of the shower door assembly of FIG. 1 illustrating another installation step according to an embodiment; and

FIG. 17 is an enlarged partial front perspective view of the shower door assembly of FIG. 1 illustrating another installation step according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc., are, in some instances, used herein to describe various elements, these elements should not be limited by these terms. These terms are only used to distinguish one element from another and are presented in order of introduction for a particular embodiment, and may vary in the introduction of various embodiments. For example, a first surface could be termed a second surface, and, similarly, a second surface could be termed a first surface, without departing from the scope of the various described embodiments. The first surface and the second surface are both surfaces, but they are not the same surface in the context of a particular embodiment.

Shower door assemblies are utilized with shower enclosures, and are designed to contain water within the enclosure and prevent it from spilling out onto a bathroom floor. Shower doors are typically made from glass, though some might employ acrylic, plastic, or any suitable pane or panel. Glass doors can be clear, frosted, or patterned to offer varying degrees of privacy and style.

Shower door assemblies offer various options and styles. For example, sliding shower door assemblies consist of two or more panels that slide along a track. Sliding shower door assemblies are compact and conserve space by not requiring extra room to swing open. Hinged or swing shower door assemblies open outward on hinges. Swing shower door assemblies require adequate space to swing open but can provide a traditional look and ease in ingress and egress. Bi-fold shower door assemblies fold in on themselves and are optimal for very tight spaces. Frameless shower door assemblies are made of tempered glass with minimal metal framing, to offer a sleek, modern look that are easier to clean. Framed shower door assemblies include a metal frame that surrounds the glass, offering extra support and sometimes additional features like built-in hardware.

Shower door assemblies offer additional features and hardware. Handles are mounted through the pane of the door. In framed designs, the handle may be mounted to the frame along an edge of the door. Handles come in various styles and finishes, from sleek chrome to brushed nickel. Rubber or silicone seals may be provided along the edges of shower doors to help prevent leaks and maintain water containment. For sliding doors, track subassemblies may include a top and sometimes a bottom track, to guide movement of the door. Some doors have built-in towel bars or hooks for added convenience, which may also be utilized as handles.

The design of a shower door can range from minimalist to ornate, depending on the overall bathroom decor. Clear glass doors can make a space feel larger and more open, while frosted or patterned glass can provide additional privacy. A selected shower door assembly combines functionality with aesthetics, helping to define a look and usability of the shower enclosure.

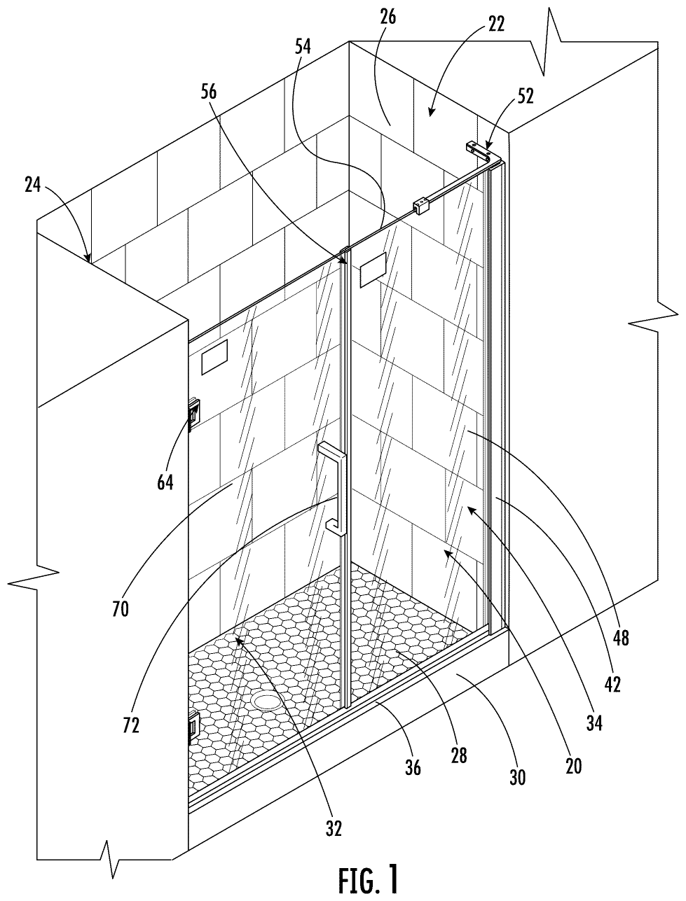

FIG. 1 illustrates a shower door assembly 20 according to an embodiment. The shower door assembly 20 is illustrated installed into a shower stall 22. The shower stall 22 includes a pair of spaced apart and opposed sidewalls 24, 26 or upright support surfaces, and an underlying floor 28. The shower stall 22 may also include a sill 30 extending up from the floor 28, as an underlying support surface. The shower door assembly 20 includes a hinged door subassembly 32 pivotally mounted to the first sidewall 24 to permit ingress and egress of an occupant into and out of the shower stall 22. The shower door assembly 20 also includes a stationary panel subassembly 34, often referred to as a fixed panel 34, or a bypass panel 34. This shower door assembly 20 provides the ability to be mounted by the installer to either the right or left side of the enclosure, such that the hinged door subassembly 32 can be either affixed to the first sidewall 24 or the second sidewall 26, depending on the preferences of the installer or end user.

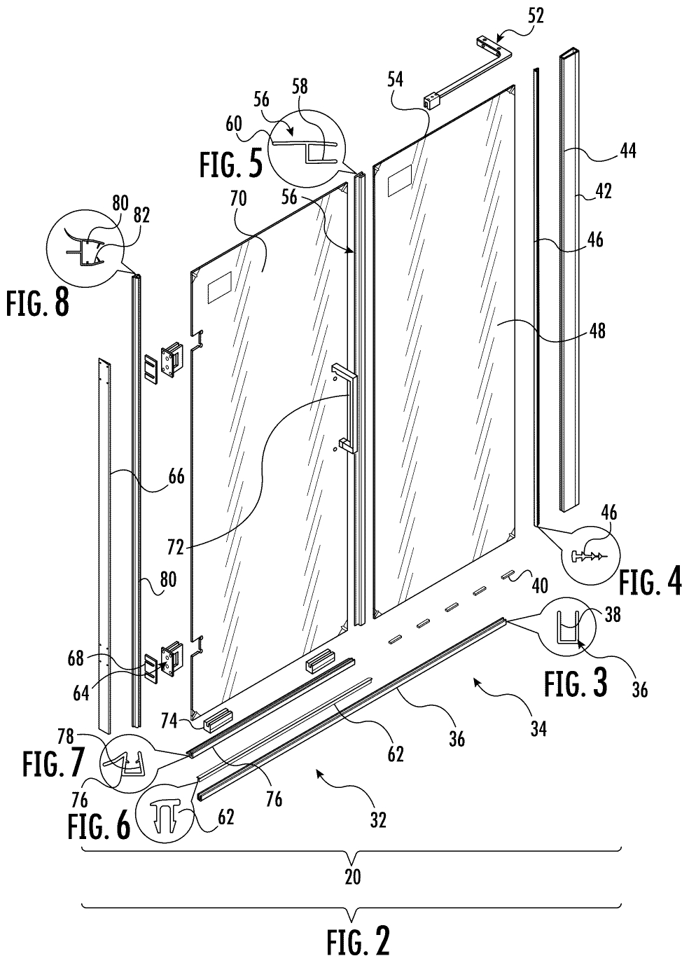

The shower door assembly 20 is also illustrated in an exploded view in FIG. 2. With reference to FIGS. 1-3, the shower door assembly 20 includes a lower rail 36. The lower rail 36 is sized to be received upon the sill 30 between the sidewalls 24, 26. The sill 30 may be sized to be cut to length at installation. As illustrated in FIG. 3, the rail 36 includes a channel 38 formed therein. The rail 36 may be provided from a structural material, such as a metallic alloy with a decorative surface finish and/or coating.

With reference now to FIG. 2, the fixed panel subassembly 34 includes plurality of supports 40 within the channel 38 to support the fixed panel subassembly 34. The supports 40 are spaced apart and are sized to be received in the channel 38. The supports 40 may be provided from a polymeric material. The supports 40 can be provided in multiple thicknesses and can be combined in such a way as to provide a vertical orientation to the sides of the fixed panel subassembly 34 and a horizontal orientation to the top of the panel-which can be helpful when a sill 30 is uneven or not level. The supports 40 provide additional protection of the panel as well as an ability to level the fixed panel subassembly 34, if desired.

A fixed panel wall jamb 42 is illustrated in FIGS. 1 and 2, which is fastened to the second sidewall 26. The wall jamb 42 may also be formed from a metallic alloy with a matching surface finish and/or coating. The wall jamb 42 also includes a channel 44 (FIG. 2) formed in a side thereof facing away from the second sidewall 26. The fixed panel wall jamb 42 is reversible for installation of the fixed panel subassembly 34 on either sidewall 24, 26.

A gasket 46 is illustrated in FIGS. 2 and 4. The gasket 46 is sized to be received in the channel 44 of the wall jamb 42, when a glass panel 48 is inserted into channel 44—such that the glass panel 48 is tightly secured into the channel 44 of wall jamb 42.

Referring again to FIGS. 1 and 2, the fixed panel subassembly 34 also includes the fixed panel 48. The fixed panel 48 may be formed from a pane of tempered glass or any suitable material. The fixed panel 48 has a width that is less than a shower door opening between the sidewalls 24, 26 of the shower stall 22. The fixed panel 48 is supported upon the supports 40 in the channel 38 of the lower rail 36. The fixed panel 48 is also received within the channel 44 of the wall jamb 42 in contact with the gasket 46 to seal the engagement of the fixed panel 48 and the wall jamb 42.

The fixed panel subassembly 34 also includes a mount subassembly 52, also known as a stay bar assembly 52. According to the depicted embodiment, the mount subassembly 52 is a hardware subassembly 52. According to at least one embodiment, the mount subassembly 52 is located at an upper end of the fixed panel subassembly 34. The mount subassembly 52 is installed to the second sidewall 26 and the wall jamb 42 and connects to the fixed panel 48 to support and brace a partially exposed upper edge 54 of the fixed panel 48. The mount subassembly 52 permits adjustment of the fixed panel 48, which is simplified in comparison to the prior art.

FIGS. 1, 2, and 5 illustrate a strike seal 56 mounted to a distal side end of the fixed panel 48. As depicted in FIG. 5, the strike seal 56 includes a channel 58 sized to receive the distal end of the fixed panel 48. The strike seal 56 also includes a flange 60 extending away from the channel 58 and the fixed panel 48 to provide a limit to a pivot range of the hinged door subassembly 32. The strike seal 56 may be formed from a polymeric material, a metallic alloy with a surface finish and/or coating, or the like.

FIGS. 2 and 6 illustrate a channel insert 62, which is sized to plug the rail channel 38 beneath the hinged door subassembly 32. The insert 62 may be contoured to descend into the stall 22 so that any water that runs or drips onto the insert 62 is directed back into the shower stall 22.

Referring again to FIGS. 1 and 2, the hinged door subassembly 32 includes a pair of hinges 64, which are fastened to the first sidewall 24. The hinged door assembly 32 is also reversible and may be mounted to either sidewall 24, 26. A template 66 is provided in FIG. 2 to assist in alignment, marking, and drilling of apertures in the first sidewall 24 to receive fasteners to attach the hinges 64. After the holes are drilled, the template 66 may be discarded or recycled. A pair of hinge shims 68 are also provided for adjustment, if applicable, of the hinged door subassembly 32. The hinge shims 68 may be formed from a flexible polymeric material, or any suitable material. The hinge shims 68 provide additional adjustment of the shower door assembly 20, as will be discussed later in further detail.

FIGS. 1 and 2 illustrate that the hinged door subassembly 32 includes a pivot door panel 70, which may be formed from a pane of tempered glass. The pivot door panel 70 is attached to the hinges 64 and supported upon the first sidewall 24. A handle 72 is mounted to the pivot door panel 70 for manual opening and closing of the hinged door subassembly 32.

FIG. 2 illustrates a pair of installation support blocks 74 which may be utilized to rest the pivot door panel 70 directly thereon to support the pivot door panel 70 while the hinges 64 are installed into the first sidewall 24. The installation support blocks 74 may be sized to rest directly upon the sill 30 prior to installation of the rail 36. After installation of the hinges 64, the support blocks 74 may be discarded or recycled.

FIGS. 2 and 7 illustrate a water diverter 76 with a channel 78 for installation upon a lower edge of the pivot door panel 70. The water diverter 76 may be formed from a polymeric material and shaped to divert water that flows down the pivot door panel 70 back into the shower stall 22.

FIGS. 2 and 8 depict a seal 80 with a channel 82 sized to receive an inner edge of the pivot door panel 70. The seal 80 is sized to engage the first sidewall 24 to seal a gap between the first sidewall 24 and the pivot door panel 70. The seal 80 may be formed from a flexible polymeric material. The seal 80 may be cut by the installer for clearance around the hinges 64.

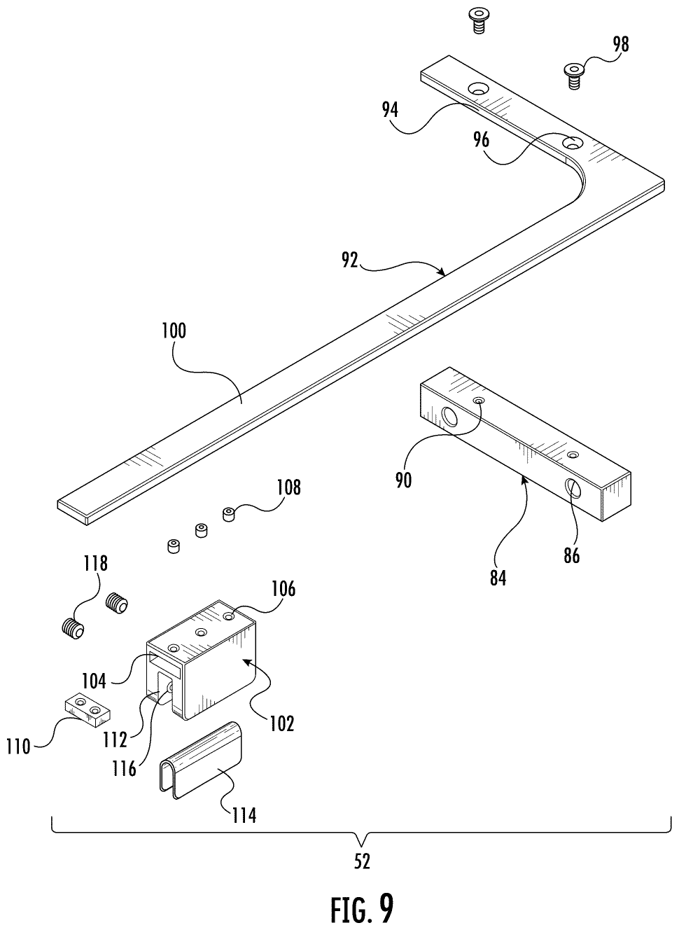

FIGS. 9-16 illustrate the mount subassembly 52 in further detail. The mount subassembly 52 includes a mount as a mount block 84, which is adapted to be mounted to one of the sidewalls 24, 26. The mount block 84 may be formed from a metallic alloy and may include a surface finish and/or coating. The mount block 84 has a body with a length, a height, and a depth. The mount block 84 includes a plurality of through apertures 86 formed through the depth direction for receipt of fasteners 88 (FIGS. 14-16). The fasteners 88 fasten the mount block 84 to the second sidewall 26 of the shower stall 22. The apertures 86 may be countersunk for receipt of heads of the fasteners 88. The mount block 84 also includes a pair of threaded apertures 90 as illustrated in FIG. 9 that are formed in a height direction. The mount block 84 is symmetrical so that the mount block 84 can be mounted to either one of the first sidewall 24 or the second sidewall 26. Therefore, one mount subassembly 52 may be employed to mount the fixed panel subassembly 34 to either the right or left sidewall 24, 26.

Referring again to FIGS. 9-12, and 14-16, the mount subassembly 52 also includes a bracket 92, which provides a brace for the fixed panel 48. The bracket 92 is formed from a metallic alloy, and may include a surface finish and/or coating. The bracket 92 includes a transverse portion 94 with a transverse width sized to cover, or partially cover, the length of the mount block 84 to be supported upon the mount block 84. In the depicted embodiment, the transverse portion 94 has a transverse width to extend beyond the mount block 84. The bracket transverse portion 94 also includes a longitudinal depth to cover, or partially cover, the depth of the mount block 84. As illustrated in FIG. 9, a pair of through apertures 96 are formed through the bracket transverse portion 94. The bracket through apertures 96 are sized to align with the mount threaded apertures 90 for receipt of fasteners 98 to fasten the bracket 92 to the mount block 84. The apertures 96 may be countersunk for receipt of heads of the fasteners 98. The mount subassembly 52 does not provide any additional adjustment feature between the bracket 92 and the mount block 84 to simplify the design and minimize components, cost, and complexity.

The bracket 92 also includes a longitudinal portion 100 extending away from the transverse portion 94 and generally perpendicular, within manufacturing tolerances, to the transverse portion 94. The longitudinal portion 100 is offset from the mount block 84 to extend over the wall jamb 42 and the fixed panel 48. The bracket 92 also has a common thickness, which may be a stock material thickness. The bracket 92 is symmetrical so that the bracket 92 can be flipped from the orientation in FIGS. 9-12 and 14-16 to be installed on the mount block 84 on the left sidewall 24. Likewise, the apertures 96 may be countersunk on both sides of the transverse portion 94 for receipt of the fasteners 98 in either installation direction.

The longitudinal portion 100 has a length to extend a distal end away from the proximal end of the transverse portion 94 to extend over the fixed panel 48 away from the second sidewall 26. The longitudinal portion 100 extends from a lateral end of the transverse portion in the shape of a capital letter ‘L’. The longitudinal portion 100 has a sufficient width to brace the fixed panel 48 and resist loads against the fixed panel 48. The longitudinal portion 100 may be sized with a length to brace fixed panels 48 of various widths for various sizes of shower door openings. The bracket 92 may be shortened by the installer by cutting the distal end of the longitudinal portion 100 to shorten the bracket 92 to the specific application. The shower door assembly 20 may include instructions for the installer to cut the bracket 92 to the appropriate size.

With continued reference to FIGS. 9, 10, 12, and 14-16, the mount subassembly 52 also includes a clamp block 102 to attach to the distal end of the bracket longitudinal portion 100 and to clamp the fixed panel 48. The clamp block 102 includes a body that may be formed from a metallic alloy and may include a surface finish and/or coating. The clamp block 102 includes a longitudinal through aperture 104 as an enclosed slot 104 that is sized to receive the distal end of the longitudinal portion 100 of the bracket 92 therein. A plurality of threaded apertures 106 are formed in a height direction through the clamp block 102 and intersecting the slot 104. A plurality of externally threaded fasteners 108 as set screws 108 are provided to be received in the threaded apertures 106. Two of the set screws 108 are employed to secure the clamp block 102 upon a position upon the longitudinal portion 100 of the bracket 92. An optional trim member 110 is provided as a plug for the exposed end of the slot 104. The trim member 110 has a surface finish and/or coating to match the other components and is installed in the slot 104 to cover a raw or cut end of the longitudinal portion 100 of the bracket 92. The trim member 110 is held in place in the slot 104 by one of the remaining set screws 108.

The clamp block 102 includes a downward facing open slot 112 that is sized to receive an upper edge of the fixed panel 48 within the slot 112. A gasket 114 is provided within the slot 112 to provide an elastomeric seal and a distributed grip between the clamp block 102 and the fixed panel 48. A plurality of threaded apertures 116 are formed in a transverse direction in the clamp block and intersecting the slot 112. Another plurality of set screws 118 are provided in the apertures 116 to engage the gasket 114 and clamp the fixed panel 48 within the clamp block 102 to clamp and support the fixed panel 48 to mount subassembly 52.

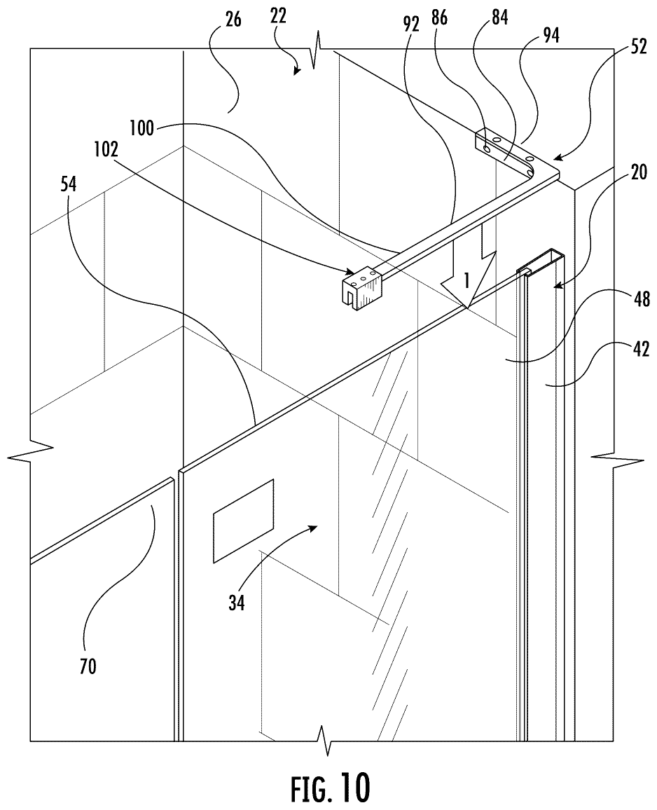

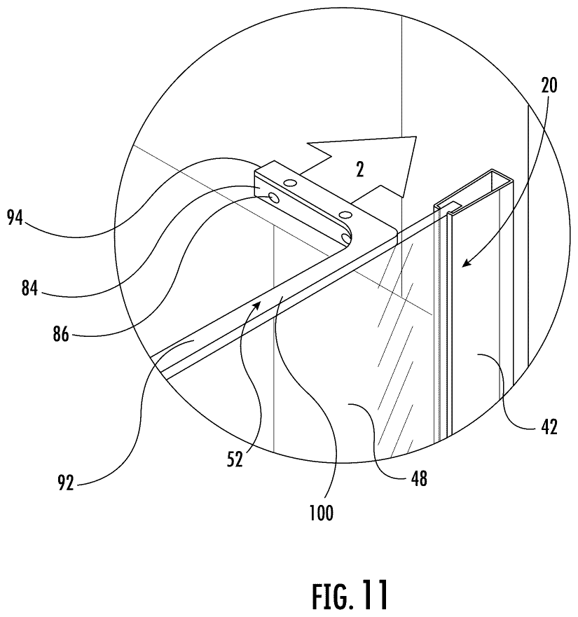

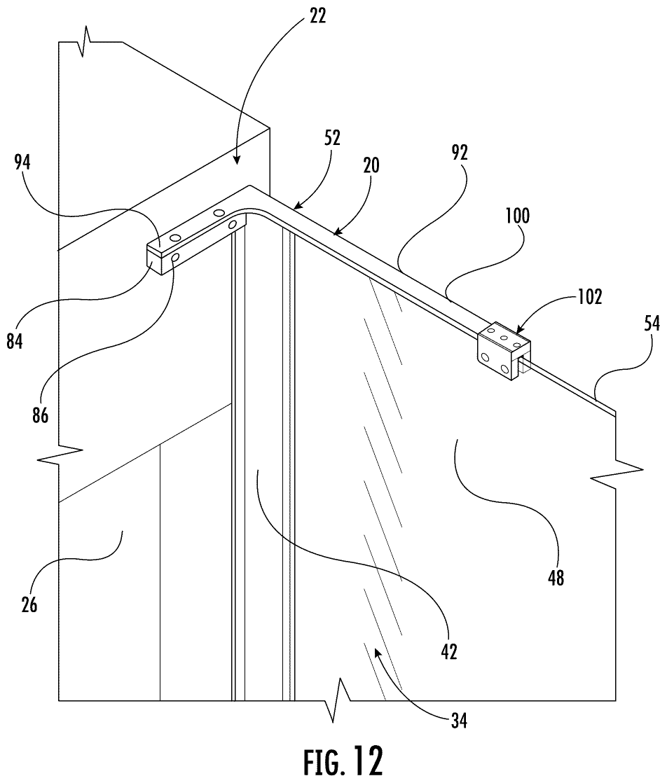

With reference to FIG. 9, installation steps for the mount subassembly are discussed in further detail. The bracket 92 is fastened to the mount block 84 by fasteners 98. The clamp block 102 is fastened to the bracket 92 by fasteners 108. The trim member 110 is fastened to the clamp block 102 by a fastener 108. Next, with reference to FIG. 10, the mount subassembly 52 is slid upon the fixed panel 48 as illustrated by arrow 1. Subsequently, and illustrated in FIG. 11, the mount subassembly 52 is then slid in the direction of arrow 2 upon the fixed panel 48 toward the second sidewall 26 to cover the wall jamb 42 as illustrated in FIG. 12.

In this position of FIG. 12, an installer may place a level upon the transverse portion 94 of the bracket 92, and shift the mount subassembly 52 until the bracket 92 is level. Once leveled, the installer may use a pencil through the apertures 86 to mark the hole pattern of the apertures 86. Subsequently, the mount subassembly 52 is removed from the fixed panel 48. Apertures are drilled into the second sidewall 26, and if necessary, wall mount anchors are installed into the apertures. The mount subassembly 52 is reinstalled on the fixed panel 48 per the steps of FIGS. 10-12. Next, the fasteners 88 are installed in the fastener apertures 86 to attach the mount block 84 to the second sidewall 26. Then, the set screws 118 are tightened to clamp the fixed panel 48 into the clamp block 102.

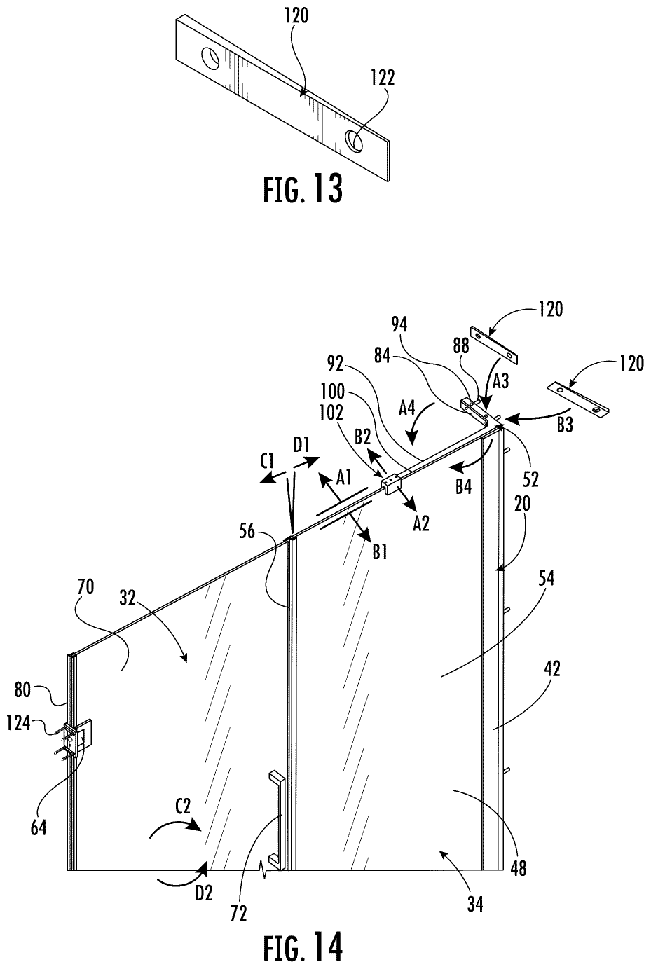

FIG. 13 illustrates an angled shim 120 for the mount subassembly 52. The shim 120 includes a length and a height sized to match the mount block 84. The shim 120 also includes an angled thickness with an angle, which may be up to five degrees. The shim 120 is reversible, as depicted in FIGS. 14-16, which thereby doubles the angular range of adjustment of the shim 120. One or more shims 120 may be provided to be stacked for a range of angular adjustment. The shim 120 also includes a pattern of apertures 122 sized to correspond with the apertures 86 of the mount block 84 to receive the fasteners 88. The shim 120 may be provided by any suitable material. One suitable shim material is silicone, which is a compressible plastic, thereby providing some flexibility to the adjustment angle of the shim 120, depending upon compression of the shim 120 from the fasteners 88. An alternate material is nylon which is relatively rigid and machinable; and nylon may also be extruded or molded. Although nylon and silicone are disclosed, any suitable material, such as a polymeric, or a thermoplastic material may be utilized. Softer or harder durometer materials may also be employed.

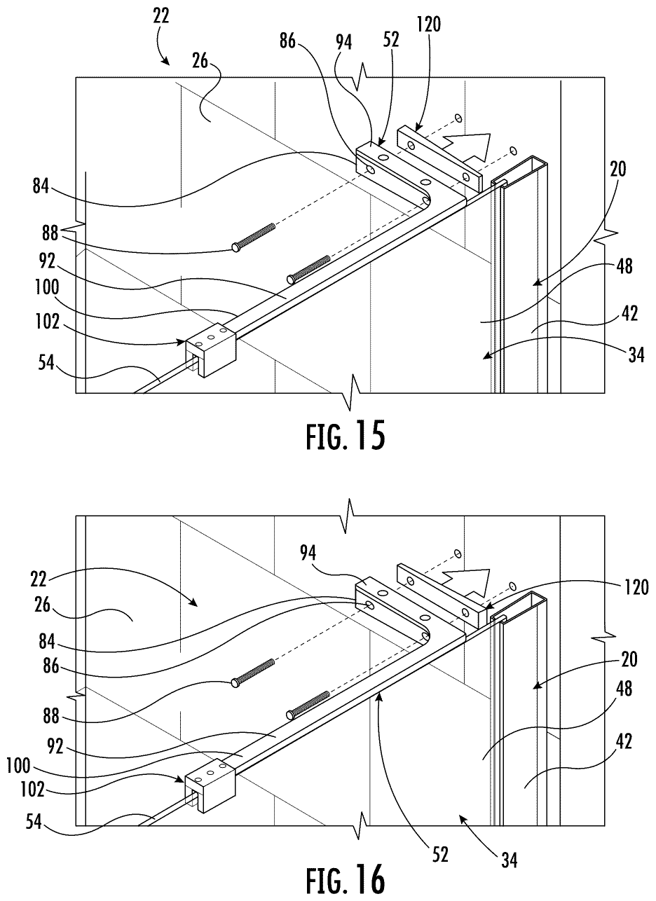

FIG. 14 illustrates the shower door assembly 20 in an installed orientation. In this orientation, fasteners 124 are installed into the hinges 64 to fasten the hinges 64 to the first sidewall 24. Additionally, the hinged door subassembly 32 is illustrated in a design or resting closed position. If the fixed panel 48 is offset from the hinged door subassembly 32 in a direction A1 into the shower stall 22, then the mount subassembly 52 can be adjusted in a direction A2. In order to do so, the shim 120 is installed in the orientation A3 to rotate the fixed panel subassembly 34 in a rotary direction A4 relative to the second sidewall 26 by rotation about a vertical axis. Referring now to FIG. 15, the screws 88 are removed; the shim 120 is installed with the enlarged thickness toward the stall 22; and the screws are refastened through the mount block 84, the shim 120, and into the second sidewall 26. If the adjustment in the direction A1 is not enough, then another shim 120 can be installed repeating these adjustment steps. The second shim 120 may have the same angle as the first shim 120, and the shims 120 may be stacked to double the angled assistance provided by the shims 120. Alternatively, the second shim 120 may have a different angle and may be stacked or may replace the first shim 120. If the adjustment is too much for alignment, then the fasteners 88 can be further tightened, thereby compressing the shim 120, or shims 120, until alignment of the panel subassemblies 32, 34 is obtained.

If the fixed panel 48 is offset from the hinged door subassembly 32 in a direction B1 away from the shower stall 22 in FIG. 14, then the mount subassembly 52 can be adjusted in a direction B2. In order to do so, the shim 120 is installed in the orientation B3 to rotate the fixed panel subassembly 34 in a rotary direction B4 relative to the second sidewall 26 and into the shower stall 22. Referring now to FIG. 16, the screws 88 are removed; the shim 120 is installed with the reduced thickness toward the stall 22; and the screws are refastened through the mount block 84, the shim 120, and into the second sidewall 26. If the adjustment in the direction B1 is not enough, then another shim 120 can be installed repeating these adjustment steps. If the adjustment is too much for alignment, then the fasteners 88 can be further tightened, thereby compressing the shim 120, or shims 120, until alignment of the panel subassemblies 32, 34 is obtained.

By adding the shim 120 as an angled support component behind the upper wall brace mount subassembly 52, the fixed panel 48 is secured in place, while gaining an additional angle of adjustment of the fixed panel 48. This adjustment of the mount subassembly 52, and consequently the fixed panel subassembly 34 permits the installer to better align the fixed panel 48 with the separate corresponding hinged or pivoting door panel subassembly 32 to complete the shower door assembly 20. The alignment of the panel subassemblies 32, 34 assists in the aesthetics and functionality of the shower door assembly 20. This adjustment is additionally useful for aligning the seal 56 with the pivot door panel 70. According to another embodiment, the seal 56 is magnetic, and the adjustment of the wall mount subassembly 52 is useful for aligning the magnetic seal 56 with another magnetic seal on the pivot door panel 70. The wall mount subassembly 52 permits the adjustment without requiring additional fasteners and other complexities that add cost and weight. The wall mount subassembly 52 permits the adjustment without requiring redrilling and reinstallation of the panel subassemblies 32, 34. The wall mount subassembly 52 also permits the adjustment without requiring uninstallation of a large quantity of components.

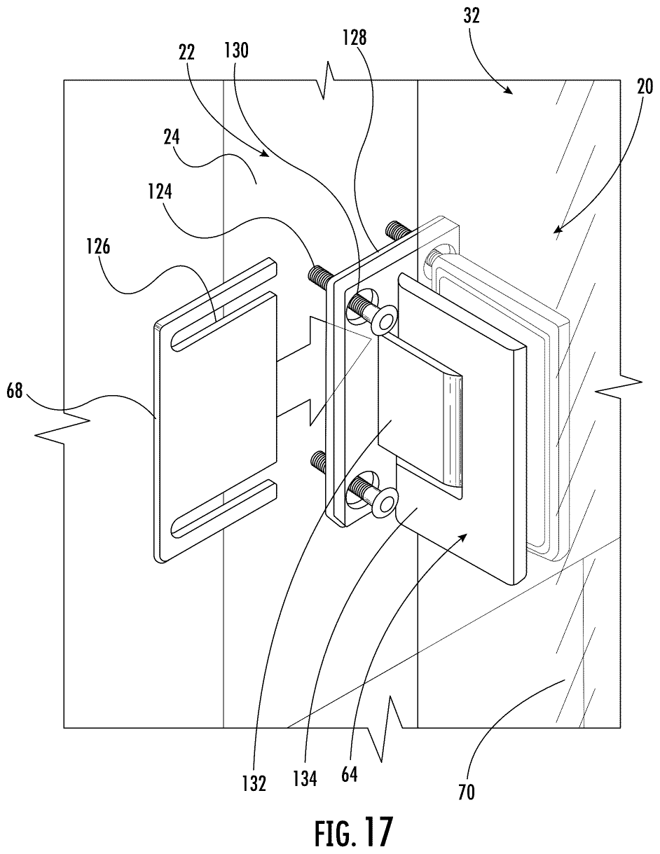

Referring again to FIG. 14, the shower door assembly 20 permits additional adjustment for alignment of a gap between the panel subassemblies 32, 34 by rotation about a horizontal axis. A gap between the panel subassemblies 32, 34 may not be aligned, due to variations in a plum or vertical alignment of the sidewalls 24, 26. If the hinged shower door panel subassembly 32 is offset from the fixed panel subassembly 34 in a direction C1, then the shim 68 can be installed behind the upper hinge 64. The hinge shim 68 is illustrated in FIGS. 2 and 17. Referring now to FIG. 17, the shim 68 includes a pair of slots 126 that are aligned with the fasteners 124. By installing the shim 68 behind the upper hinge 64 as depicted in FIG. 17, the hinged shower door subassembly 32 is pivoted about a horizontal axis in direction C2 in FIG. 14 to align the panels 48, 70 in a parallel and vertical orientation. If the hinged door panel subassembly 32 requires further adjustment in the direction C2, an additional shim 68 can be installed behind the upper hinge 64. The shim 68 may be formed from a compressible polymeric material. If overadjustment is reached, the fasteners 124 of the upper hinge 64 can be further tightened to compress the shim 68 or shims 68 until a target orientation is reached.

If the hinged shower door panel subassembly 32 is offset from the fixed panel subassembly 34 in a direction D1, then the shim 68 can be installed behind the lower hinge 64. By installing the shim 68 behind the lower hinge 64 as depicted in FIG. 17, the hinged shower door subassembly 32 is pivoted about a horizontal axis in direction D2 in FIG. 14 to align the panels 48, 70 in a parallel and vertical orientation. If the hinged door panel subassembly 32 requires further adjustment in the direction D2, an additional shim 68 can be installed behind the lower hinge 64. If overadjustment is reached, the fasteners 124 of the lower hinge 64 can be further tightened to compress the shim 68 or shims 68 until a target orientation is reached.

Referring again to FIG. 17, each of the hinges 64 includes a mounting plate 128 to be mounted to the sidewall 24. The mounting plate 128 includes a plurality of apertures 130 to receive the fasteners 124, which fasten the mounting plates 128 to the sidewall 24. Each hinge 64 includes a knuckle 132 projected from the mounting plate 128. A pair of hinge leaves 134 clamp to the shower door panel 70 and are pivotally connected to the knuckle 132.

In order to install the shim 68, the installer loosens the screws 124 to provide a gap between the mounting plate 128 and the first sidewall 24. Then, the installer slides the shim 68 between the mounting plate 128 and the first sidewall 24 by sliding the shim in the direction indicated in FIG. 17 whereby the slots 126 receive the fasteners 124 within the slots 126. Then, the installer retightens the fasteners 124. The slotted shim 68 permits adjustment of the hinged shower door subassembly 32 without removing the hinged shower door subassembly 32 from the first sidewall 24.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A shower door hardware assembly comprising:
a mount adapted to be mounted to an upright support surface;
a bracket attachable to the mount;
a clamp oriented on the bracket to receive, clamp, and support a shower door panel; and
a shim sized to be received between the mount and the upright support surface to adjust a position of the bracket relative to the upright support surface.

2. The shower door hardware assembly of claim 1, wherein the bracket is not adjustable relative to the mount.

3. The shower door hardware assembly of claim 1, wherein an aperture is formed through the clamp and sized to receive a distal end of the bracket.

4. The shower door hardware assembly of claim 3, further comprising a plug sized to be received in the aperture of the clamp.

5. The shower door hardware assembly of claim 4, wherein the clamp comprises a surface finish or a coating; and
wherein the plug comprises a surface finish or a coating to match that of the clamp.

6. The shower door hardware assembly of claim 4, further comprising a fastener in cooperation with the clamp and the plug to retain the plug within the aperture of the clamp.

7. The shower door hardware assembly of claim 1, wherein the shim comprises an angled thickness.

8. The shower door hardware assembly of claim 7, wherein an angle of the angled thickness of the shim is five degrees or less.

9. The shower door hardware assembly of claim 1, wherein the shim comprises a length and a height sized to match the mount.

10. The shower door hardware assembly of claim 1, wherein the shim comprises a polymeric material.

11. The shower door hardware assembly of claim 1, wherein the shim comprises a silicone material.

12. The shower door hardware assembly of claim 1, wherein the shim comprises a nylon material.

13. A shower door assembly comprising:
a panel sized to be installed in a shower stall opening; and
the shower door hardware assembly of claim 1 to install and support the panel in the shower stall opening.

14. The shower door assembly of claim 13, further comprising:
a channel sized to be installed to a sill of the shower stall opening and sized to receive the panel in the channel; and
a support sized to be received within the channel to receive and support the panel.

15-20. (canceled)

21. A shower door hardware assembly comprising:
a mount adapted to be mounted to a first upright support surface;
a bracket attachable to the mount at a proximal end of the bracket, wherein the bracket is not adjustable relative to the mount;
a clamp oriented at a distal end of the bracket to receive, clamp, and support a shower door panel;
a hinge subassembly with a plurality of apertures to be fastened to a second upright support surface and to pivotally support a shower door panel relative to the second upright support surface; and
a shim sized to be received between the hinge subassembly and the second upright support surface to adjust a position of the hinge subassembly relative to the second upright support surface, wherein the shim includes a slot aligned with at least one of the plurality of apertures for installation while the hinge subassembly is fastened to the second upright support surface.

22. A method comprising:
installing a hinged shower door to a first upright support surface;
installing a fixed shower door panel to a second upright support surface that is spaced apart and opposed to the first upright support surface; and
installing a shim between the fixed shower door panel and the second upright support surface to align the fixed shower door with the hinged shower door.

23. The method of claim 22, further comprising:
cutting a bracket to length; and
installing the bracket to the fixed shower door panel and the second upright support surface.

24. The method of claim 23, further comprising:
installing a trim member to conceal a cut end of the bracket.

25. The method of claim 24, further comprising:
installing a clamp on the bracket;
clamping the clamp upon the fixed shower door panel; and
installing the trim member on the clamp.

26. The method of claim 24, further comprising:
installing a clamp on the bracket;
sliding the clamp onto the fixed shower door panel;
sliding the bracket into engagement with the first upright support surface;
installing the bracket to the first upright support surface; and
clamping the fixed shower door panel to the clamp.

27-29. (canceled)
